(19) United States
(12) Patent Application Publication
(10) Pub. No.: US 2025/0167246 A1
(43) Pub. Date: May 22, 2025

(54) ALL-SOLID-STATE RECHARGEABLE BATTERIES

(71) Applicant: SAMSUNG SDI CO., LTD., Yongin-si (KR)

(72) Inventors: Jaehwan HA, Yongin-si (KR); Yujin KANG, Yongin-si (KR); Dongho KOO, Yongin-si (KR); Juyun KIM, Yongin-si (KR)

(21) Appl. No.: 18/931,192

(22) Filed: Oct. 30, 2024

(30) Foreign Application Priority Data
Nov. 17, 2023 (KR) 10-2023-0159770
Nov. 17, 2023 (KR) 10-2023-0159771
Nov. 17, 2023 (KR) 10-2023-0159772

(51) Int. Cl. H01M 4/62; H01M 4/02; H01M 4/36; H01M 10/0562

(52) U.S. Cl. CPC H01M 4/628; H01M 4/366; H01M 10/0562; H01M 2004/021; H01M 2004/028; H01M 2300/008

(57) ABSTRACT

An all-solid-state rechargeable battery includes a positive electrode having a positive electrode current collector, a positive electrode active material layer on the positive electrode current collector, the positive electrode active material layer including a positive electrode active material and a sulfide solid electrolyte, and a safety functional layer on the positive electrode active material layer, the safety functional layer including an olivine positive electrode active material, a negative electrode, and a solid electrolyte layer between the positive electrode and the negative electrode, the solid electrolyte layer including the sulfide solid electrolyte.

### CROSS-REFERENCE TO RELATED APPLICATION

This application claims priority to and the benefit of Korean Patent Application No. 10-2023-0159772, filed in the Korean Intellectual Property Office on Nov. 17, 2023, Korean Patent Application No. 10-2023-0159771, filed in the Korean Intellectual Property Office on Nov. 17, 2023, and Korean Patent Application No. 10-2023-0159770, filed in the Korean Intellectual Property Office on Nov. 17, 2023, the entire contents of which are incorporated herein by reference.

### BACKGROUND

### 1. Field

All-solid-state rechargeable batteries are disclosed.

### 2. Description of the Related Art

A portable information device such as a cell phone, a laptop, smart phone, and the like or an electric vehicle may use a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there may be safety issues, e.g., explosion or fire, in the event of collision, penetration, and the like. Accordingly, a semi-solid battery or an all-solid-state battery that avoids the use of electrolyte solutions is being proposed. An all-solid-state battery is a battery in which all materials are made of solid, e.g., a battery that uses solid electrolytes. The all-solid-state battery has the merit of not having a risk of explosion due to electrolyte solution leakage and the like, and that it is easy to manufacture a thin battery.

### SUMMARY

In some example embodiments, an all-solid-state rechargeable battery includes a positive electrode including a positive electrode current collector, a positive electrode active material layer on the positive electrode current collector, and a safety functional layer on the positive electrode active material layer; a negative electrode; and a solid electrolyte layer between the positive electrode and the negative electrode, wherein the positive electrode active material layer includes positive electrode active material and sulfide solid electrolyte, the safety functional layer includes an olivine positive electrode active material, and the solid electrolyte layer includes the sulfide solid electrolyte.

### BRIEF DESCRIPTION OF THE DRAWINGS

Features will become apparent to those of skill in the art by describing in detail exemplary embodiments with reference to the attached drawings, in which:

FIGS. 1 and 2 are schematic cross-sectional views of an all-solid-state rechargeable battery according to some example embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof “Layer” includes not only a shape formed on the whole surface when viewed from a plan view, but also a shape formed on a partial surface.

The average particle diameter may be measured by a method well known to those skilled in the art, e.g., may be measured by a particle size analyzer, or may be measured by a transmission electron micrograph or a scanning electron micrograph. Alternatively, it is possible to obtain an average particle diameter value by measuring using a dynamic light scattering method, performing data analysis, counting the number of particles for each particle size range, and calculating from this. The average particle diameter may mean a diameter (D₅₀) of particles having a cumulative volume of 50 volume % in a particle size distribution. As used herein, when a definition is not otherwise provided, the average particle diameter means a diameter (D₅₀) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

Some example embodiments provide all-solid-state rechargeable battery including a positive electrode, a negative electrode, and a solid electrolyte layer between the positive electrode and the negative electrode.

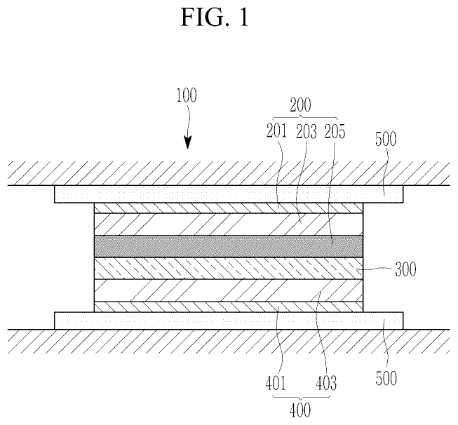

FIG. 1 is a cross-sectional view of an all-solid-state rechargeable battery according to some example embodiments.

Referring to FIG. 1, an all-solid-state rechargeable battery 100 may include an electrode assembly, in which a negative electrode 400 (including a negative electrode current collector 401 and a negative electrode active material layer 403), a solid electrolyte layer 300, and a positive electrode 200 (including a positive electrode current collector 201, a positive electrode active material layer on the positive electrode current collector 203, and a safety functional layer 205 on the positive electrode active material layer) are stacked, is housed in a battery case. The all-solid-state rechargeable battery 100 may further include an elastic layer 500 outside at least one of the positive electrode 200 and the negative electrode 400. FIG. 1 shows one electrode assembly including the negative electrode 400, the solid electrolyte layer 300, and the positive electrode 200, but two or more electrode assemblies (e.g., two (2) to two hundred (200), three (3) to one hundred (100), or four (4) to fifty (50) electrode assemblies) may be stacked to manufacture an all-solid-state rechargeable battery.

### Positive Electrode

In some example embodiments, the all-solid-state rechargeable battery 100 may include the positive electrode 200 including the positive electrode current collector 201, the positive electrode active material layer 203 on the electrode current collector 201, and the safety functional layer 205 on the positive electrode active material layer 203. For example, referring to FIG. 1, the safety functional layer 205 may be between the positive electrode active material layer 203 and the solid electrolyte layer 300.

The positive electrode active material layer 203 may include a positive electrode active material and a sulfide solid electrolyte, the safety functional layer 205 may include an olivine positive electrode active material, and the solid electrolyte layer 300 may include a sulfide solid electrolyte. The safety functional layer 205 may further include a sulfide solid electrolyte.

The sulfide solid electrolyte of the positive electrode active material layer 203 and the sulfide solid electrolyte of the solid electrolyte layer 300 may be the same or different from each other. In addition, when the safety functional layer 205 further includes the sulfide solid electrolyte, the sulfide solid electrolyte of the positive electrode active material layer 203, the sulfide solid electrolyte of the safety functional layer 205, and the sulfide solid electrolyte of the solid electrolyte layer 300 may be the same or different from each other.

### Safety Functional Layer

The safety functional layer 205 may include the olivine positive electrode active material. The olivine positive electrode active material is a positive electrode active material with a hexahedral shape, which exhibits, compared to a positive electrode active material with a layered structure, excellent lattice structural stability, less deterioration of its crystal structure even though lithium ions escape during the discharge, and very excellent thermal stability.

The all-solid-state battery according to some example embodiments may include the safety functional layer 205 including the olivine positive electrode active material, thereby reducing exothermic heat, when a short circuit occurs between positive and negative electrodes due to internal short circuit or damage caused by an external force (penetration, collision, etc.), and blocking a direct contact of the positive and negative electrodes to prevent thermal runaway due to collapse of the active material.

The olivine positive electrode active material may be a lithium transition metal phosphate, e.g., lithium iron phosphate, lithium manganese iron phosphate, lithium manganese phosphate, lithium titanium phosphate, or a combination thereof. The olivine positive electrode active material may be, e.g., represented by Chemical Formula 1, Chemical Formula 2, Chemical Formula 3, Chemical Formula 4, or Chemical Formula 5.

Liₐ₁Fe₍₁₋ₓ₁₎M¹ₓ₁PO₄ [Chemical Formula 1]

In Chemical Formula 1, 0.90≤a1≤1.5, 0≤x1≤0.4, and M¹ may be Al, Ca, Ce, Cr, Cu, Co, La, Mg, Mo, Nb, Ni, Sn, Sr, V, W, Y, Zn, Zr, or a combination thereof. The compound represented by Chemical Formula 1 may be referred to as lithium iron phosphate. For example, in Chemical Formula 1, 0.90≤a1≤1.2 (e.g., 0.95≤a1≤1.1) and 0≤x1≤0.3 (e.g., 0≤x1≤0.2, 0≤x1≤0.1, or 0<x1≤0.05). For example, if a1=1 and x1=0, Chemical Formula 1 may be represented by LiFePO₄.

Liₐ₂Mnₓ₂Fe_{(1-X2-y2)}M²_{y2}PO₄ [Chemical Formula 2]

In Chemical Formula 2, 0.90≤a2≤1.5, 0.1≤x2≤0.9, and M² may be Al, Ca, Ce, Cr, Cu, Co, La, Mg, Mo, Nb, Ni, Sn, Sr, V, W, Y, Zn, Zr, or a combination thereof. The compound represented by Chemical Formula 2 may be referred to as lithium manganese iron phosphate. For example, in Chemical Formula 2, 0.90≤a2≤1.2 (e.g., 0.95≤a2≤1.1) and 0.2≤x2≤0.8 (e.g., 0.3≤x2≤0.7 or 0.4≤x2≤0.6). For example, the compound represented by Chemical Formula 2 may be LiMn_{0.9}Fe_{0.1}PO₄, LiMn_{0.8}Fe_{0.2}PO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, LiMn_{0.2}Fe_{0.8}PO₄, or LiMn_{0.1}Fe_{0.9}PO₄.

Liₐ₃Mn₍₁₋ₓ₃₎M³ₓ₃PO₄ [Chemical Formula 3]

In Chemical Formula 3, 0.90≤a3≤1.5, 0≤x3≤0.4, and M³ may be Al, Ca, Ce, Cr, Cu, Co, La, Mg, Mo, Nb, Ni, Sn, Sr, V, W, Y, Zn, Zr, or a combination thereof. The compound represented by Chemical Formula 3 may be referred to as lithium manganese phosphate. For example, in Chemical Formula 3, 0.90≤a3≤1.2 (e.g., 0.95≤a3≤1.1) and 0≤x3≤0.3 (e.g., 0≤x3≤0.2, 0≤x3≤0.1, or 0≤x3≤0.05). For example, if a3=1 and x3=0, Chemical Formula 3 may be represented by LiMnPO₄.

Liₐ₄Ti₍₂₋ₓ₄₎M⁴ₓ₄(PO₄)₃ [Chemical Formula 4]

In Chemical Formula 4, 0.90≤a4≤1.5, 0≤x4≤0.4, and M⁴ may be Al, Ca, Ce, Cr, Cu, Co, La, Mg, Mo, Nb, Ni, Sn, Sr, V, W, Y, Zn, Zr, or a combination thereof. The compound represented by Chemical Formula 4 may be referred to as lithium titanium phosphate. For example, in Chemical Formula 4, 0.90≤a4≤1.2 (e.g., 0.95≤a4≤1.1) and 0≤x4≤0.3 (e.g., 0≤x4≤0.2, 0≤x4≤0.1, or 0≤x4≤0.05). For example, if a4=1 and x4=0, Chemical Formula 4 may be represented by LiTi₂(PO₄)₃.

Liₐ₅Ti₍₁₋ₓ₅₎M⁵ₓ₅PO₅ [Chemical Formula 5]

In Chemical Formula 5, 0.90≤a5≤1.5, 0≤x5≤0.4, and M⁵ may be Al, Ca, Ce, Cr, Cu, Co, La, Mg, Mo, Nb, Ni, Sn, Sr, V, W, Y, Zn, Zr, or a combination thereof. The compound represented by Chemical Formula 5 may be referred to as lithium titanium phosphate. For example, in Chemical Formula 5, 0.90≤a5≤1.2 (e.g., 0.95≤a5≤1.1) and 0≤x5≤0.3 (e.g., 0≤x5≤0.2, 0≤x5≤0.1, or 0≤x5≤0.05). For example, if a5=1 and x5=0, Chemical Formula 5 may be represented by LiTiPO₅.

As a specific example, the olivine positive electrode active material may include LiFePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, LiMnPO₄, LiTiPO₅, LiTi₂(PO₄)₃, or a combination thereof.

For example, the olivine positive electrode active material may be a type of primary particle, and its average particle diameter (D₅₀) may be about 10 nm to about 2 m (e.g., about 50 nm to about 1.5 μm, about 100 nm to about 1.0 μm, about 100 nm to about 1.0 μm, about 100 nm to about 900 nm, or about 100 nm to about 600 nm). If the average particle diameter of the olivine positive electrode active material satisfies the above range, the safety of the battery can be maximized.

Herein, the average particle diameter means a diameter (D₅₀) of particles having a cumulative volume of 50 volume % in the particle size distribution that is obtained by measuring the size (diameter or length of the major axis) of about 20 particles at random in a scanning electron microscope image for positive electrode active materials.

The olivine positive electrode active material may be included in an amount of about 70 wt % to about 99 wt % (e.g., about 70 wt % to about 95 wt % or about 75 wt % to about 95 wt %), based on 100 wt % of the safety functional layer 205. If the above range is satisfied, an all-solid-state rechargeable battery can be implemented that is excellent in reducing the heat generation amount of the battery and preventing thermal runaway.

The safety functional layer 205 may further include a sulfide solid electrolyte. A detailed description of the sulfide solid electrolyte will be described later in the section on the solid electrolyte layer 300.

The sulfide solid electrolyte of the safety functional layer 205 may include small particles with an average particle diameter (D₅₀) of about 0.1 μm to about 1.9 μm.

The sulfide solid electrolyte may be included in an amount of about 1 wt % to about 30 wt % (e.g., about 3 wt % to about 30 wt %, about 5 wt % to about 30 wt %, or about 5 wt % to about 25 wt %), based on 100 wt % of the safety functional layer 205. When included in the above amount range, the safety of the battery can be effectively implemented while ensuring the ionic conductivity of the safety functional layer.

A weight ratio of the olivine positive electrode active material and the sulfide solid electrolyte included in the safety functional layer may be about 70:30 to about 97:3 (e.g., about 75:25 to about 97:3 or about 75:25 to about 95:5). When the above weight ratio is satisfied, the safety of the battery can be effectively implemented while ensuring the ionic conductivity of the safety functional layer.

The safety functional layer 205 may optionally further include a binder and/or a conductive material. In case when the safety functional layer 205 further includes the binder, the binder can serve to ensure that the olivine positive electrode active material particles adhere to each other and the olivine positive electrode active material to the positive electrode active material layer. The conductive material may provide conductivity to the safety functional layer 205.

A detailed description of the binder and the conductive material will be described later with respect to the positive electrode active material layer 203 section.

An amount of the binder in the safety functional layer 205 may be about 0.1 wt % to about 25 wt % (e.g., about 0.1 wt % to about 20 wt % or about 0.5 wt % to about 15 wt %), based on 100 wt % of the safety functional layer. If the above range is satisfied, the safety of the battery can be ensured and the adhesion between olivine positive electrode active material particles in the safety functional layer can be improved.

An amount of the conductive material in the safety functional layer 205 may be about 0 wt % to about 20 wt % (e.g., about 1 wt % to about 15 wt % or about 2 wt % to about 15 wt %), based on 100 wt % of the safety functional layer 205. If the above range is satisfied, conductivity can be provided to the safety functional layer while ensuring the safety of the battery.

A thickness of the safety functional layer 205 may be about 1 μm to about 15 μm (e.g., about 1 μm to about 10 μm, about 5 μm to about 10 μm, or about 5 μm to about 8 μm). If the above thickness range is satisfied, an all-solid-state rechargeable battery with excellent safety can be implemented.

### Positive Electrode Active Material Layer

The positive electrode active material layer 203 may include a positive electrode active material and a sulfide solid electrolyte, and may optionally include a binder and/or a conductive material. Any suitable positive electrode active material can be implemented. For example, the positive electrode active material may be a compound being capable of intercalating and deintercalating lithium, may include a lithium transition metal composite oxide, and may include a compound represented by any of the following chemical formulas:

LiₐA_{1-b}X_{b}D′₂(0.90≤a≤1.8,0≤b≤0.5);

LiₐA_{1-b}X_{b}O_{2-c}D′_{c}(0.90≤a≤1.8,0≤b≤0.5,0≤c≤0.05);

LiₐE_{1-b}X_{b}O_{2-c}D′_{c}(0.90≤a≤1.8,0≤b≤0.5,0≤c≤0.05);

LiₐE_{2-b}X_{b}O_{4-c}D′_{c}(0.90≤a≤1.8,0≤b≤0.5,0≤c≤0.05);

LiₐNi_{1-b-c}Co_{b}X_{c}D′ₐ(0.90≤a≤1.8,0≤b≤0.5,0≤c≤0.5,0≤α≤2);

LiₐNi_{1-b-c}Co_{b}X_{c}O_{2-α}T_{α}(0.90≤a≤1.8, 0≤b≤0.5, 0≤c≤0.05,0≤α≤2);

LiₐNi_{1-b-c}Co_{b}X_{c}O_{2-α}T₂(0.90≤a≤1.8,0≤b≤0.5,0≤c≤0.05,0≤a≤2);

LiₐNi_{1-b-c}Mn_{b}X_{c}D′_{α}(0.90≤a≤1.8,0≤b≤0.5,0≤c≤0.05,0≤α≤2);

LiₐNi_{1-b-c}Mn_{b}X_{c}O_{2-α}T_{α}(0.90≤a≤1.8,0≤b≤0.5,0≤c≤0.05,0≤a≤2);

LiₐNi_{1-b-c}Mn_{b}X_{c}O_{2-α}T₂(0.90≤a≤1.8,0≤b≤0.5,0≤c≤0≤α≤2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2); and

LiₐFePO₄(0.90≤a≤1.8).

In the chemical formulas, A may be selected from Ni, Co, Mn, and a combination thereof, X may be selected from Al, Ni, Co, Mn, Cr, Fe, Mg, Sr, V, rare earth elements, and a combination thereof, D′ may be selected from O, F, S, P, and a combination thereof, E may be selected from Co, Mn, and a combination thereof, T may be selected from F, S, P, and a combination thereof, G may be selected from Al, Cr, Mn, Fe, Mg, La, Ce, Sr, V, and a combination thereof, Q may be selected from Ti, Mo, Mn, and a combination thereof, Z may be selected from Cr, V, Fe, Sc, Y, and a combination thereof, and J may be selected from V, Cr, Mn, Co, Ni, Cu, and a combination thereof.

The positive electrode active material may be, e.g., a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

The positive electrode active material may include, e.g., lithium nickel oxide represented by Chemical Formula 6, lithium cobalt oxide represented by Chemical Formula 7, lithium iron phosphate compound represented by Chemical Formula 8, cobalt-free lithium nickel-manganese oxide represented by Chemical Formula 9, or a combination thereof, and as a specific example lithium nickel oxide represented by Chemical Formula 6 or lithium cobalt oxide represented by Chemical Formula 7.

Liₐ₆Niₓ₆M⁶_{y6}M⁷_{z6}O_{2-b6}X_{b6} [Chemical Formula 6]

In Chemical Formula 6, 0.9≤a6≤1.8, 0.3≤x6≤1, 0≤y6≤0.7, 0≤z6≤0.7, 0.9≤x6+y6+z6≤1. 1, 0≤b6≤0.1, M⁶ and M⁷ may each be independently one or more elements selected from Al, B, Ba, Ca, Ce, Co, Cr, Cu, Fe, Mg, Mn, Mo, Nb, Si, Sn, Sr, Ti, V, W, and Zr, and X may be one or more elements selected from F, P and S. In Chemical Formula 6, 0.6≤x6≤1, 0≤y6≤0.4, and 0≤z6≤0.4 (e.g., 0.8≤x6≤1, 0≤y6≤0.2, and 0≤z6≤0.2).

Liₐ₇Coₓ₇M⁸_{y7}O_{2-b7}X_{b7} [Chemical Formula 7]

In Chemical Formula 7, 0.9≤a7≤1.8, 0.7≤x7≤1, 0≤y7≤0.3, 0.9≤x7+y7≤1.1, and 0≤b7≤0.1, M⁸ may be one or more elements selected from Al, B, Ba, Ca, Ce, Cr, Cu, Fe, Mg, Mn, Mo, Ni, Se, Si, Sn, Sr, Ti, V, W, Y, Zn, and Zr, and X may be one or more elements selected from F, P, and S.

Liₐ₈Feₓ₈M⁹_{y8}PO_{4-b8}X_{b8} [Chemical Formula 8]

In Chemical Formula 8, 0.9≤a8≤1.8, 0.6≤x8≤1, 0≤y8≤0.4, and 0≤b8≤0.1, M⁹ may be one or more elements selected from Al, B, Ba, Ca, Ce, Co, Cr, Cu, Mg, Mn, Mo, Ni, Se, Si, Sn, Sr, Ti, V, W, Y, Zn, and Zr, and X may be one or more elements selected from F, P, and S.

Liₐ₉Niₓ₉Mn_{y9}M¹⁰_{z9}O_{2-b9}X_{b9} [Chemical Formula 9]

In Chemical Formula 9, 0.9≤a9≤1.8, 0.8≤x9≤1, 0≤y9≤0.2, 0≤z9≤0.2, 0.9≤x9+y9+z9≤1.1, and 0≤b9≤0.1, M¹⁰ may be one or more elements selected from Al, B, Ba, Ca, Ce, Cr, Fe, Mg, Mo, Nb, Si, Sn, Sr, Ti, V, W, and Zr, and X may be one or more elements selected from F, P and S.

An average particle diameter (D₅₀) of the positive electrode active material may be about 1 μm to about 25 μm (e.g., about 3 μm to about 25 μm, about 1 μm to about 20 μm, about 1 μm to about 18 μm, about 3 μm to about 15 μm, or about 5 μm to about 15 m). For example, the positive electrode active material may include small particles having an average particle diameter (Do) of about 1 μm to about 9 μm and large particles having an average particle diameter (D₅₀) of about 10 μm to about 25 μm. The positive electrode active material having this particle size range can be harmoniously mixed with other components within the positive electrode active material layer and can achieve high capacity and high energy density. Herein, the average particle diameter means a diameter of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the particle surface. The buffer layer may be expressed as a coating layer, a protective layer, etc., and may serve to lower the interfacial resistance between the positive electrode active material and the sulfide solid electrolyte particles. For example, the buffer layer may include lithium-metal-oxide, wherein the metal is, e.g., one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of about 55 wt % to about 99 wt % (e.g., about 65 wt % to about 95 wt % or about 75 wt % to about 91 wt %), based on 100 wt % of the positive electrode active material layer.

The positive electrode active material layer 203 may include a sulfide solid electrolyte, and a detailed description thereof will be provided later in the solid electrolyte layer 300 section.

The sulfide solid electrolyte of the positive electrode active material layer may include small particles with an average particle diameter (D₅₀) of about 0.1 μm to about 1.9 μm. The sulfide solid electrolyte may be included in an amount of about 0.1 wt % to about 35 wt % (e.g., about 1 wt % to about 35 wt %, about 5 wt % to about 30 wt %, about 8 wt % to about 25 wt %, or about 10 wt % to about 20 wt %), based on 100 wt % of the positive electrode active material layer.

Additionally, the positive electrode active material may be included in an amount of about 65 wt % to about 99 wt % and the sulfide solid electrolyte may be included in an amount of about 1 wt % to about 35 wt % (e.g., the positive electrode active material may be included in an amount of about 80 wt % to about 90 wt % and the sulfide solid electrolyte may be included in an amount of about 10 wt % to about 20 wt %), based on a total weight of the positive electrode active material and the sulfide solid electrolyte in the positive electrode active material layer. If the sulfide solid electrolyte is included in the positive electrode at this amount, the efficiency and cycle-life characteristics of the all-solid-state battery can be improved without reducing capacity.

In the case when a binder is further included in the positive electrode active material layer 203, the binder serves to adhere the positive electrode active material particles to each other and also to properly attach the positive electrode active material to the current collector.

The binder may include, e.g., polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or a combination.

An amount of the binder may be about 0.1 wt % to about 5 wt % in the positive electrode active material layer 203, based on 100 wt % of the positive electrode active material layer.

The positive electrode active material layer 203 may further include conductive material. The conductive material is used to impart conductivity to the electrode, and any suitable material that does not cause chemical change and conducts electrons can be used in the battery. Examples of the conductive material may include a carbon material such as natural graphite, artificial graphite, carbon black, acetylene black, ketjen black, a carbon fiber, a carbon nanofiber, a carbon nanotube, and the like; a metal material including copper, nickel, aluminum, silver, etc. in a form of a metal powder or a metal fiber; a conductive polymer such as a polyphenylene derivative; or a mixture thereof.

An amount of the conductive material in the positive electrode active material layer may be about 0 wt % to about 3 wt % (e.g., about 0.01 wt % to about 2 wt % or about 0.1 wt % to about 1 wt %), based on 100 wt % of the positive electrode active material layer.

Aluminum foil may be used as the positive electrode current collector 201.

### Solid Electrolyte Layer

The solid electrolyte layer 300 may include a solid electrolyte, and the solid electrolyte may include a sulfide solid electrolyte. The sulfide solid electrolyte particles may include, e.g., Li₂S—P₂S₅, Li₂S—P₂S₅—LiX (wherein X is a halogen element, e.g., I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn or Ga), Li₂S—GeS₂, Li₂S—SiS₂—Li₃PO₄, Li₂S—SiS₂—LiₚMO_{q} (wherein p and q each an integer and M is P, Si, Ge, B, Al, Ga, or In), or a combination thereof.

The sulfide solid electrolyte may be obtained by, e.g., mixing Li₂S and P₂S₅ in a molar ratio of about 50:50 to about 90:10 (e.g., about 50:50 to about 80:20) and optionally performing heat treatment. Within the above mixing ratio range, a sulfide solid electrolyte having excellent ionic conductivity may be prepared. The ionic conductivity may be further improved by adding SiS₂, GeS₂, B₂S₃, and the like as other components thereto.

Mechanical milling or a solution method may be applied as a mixing method of sulfur-containing raw materials for preparing a sulfide solid electrolyte. The mechanical milling is to make starting materials into particulates by putting the starting materials in a reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide solid electrolyte may be prepared by mixing sulfur-containing raw materials and heat-treating the mixture two or more times. In this case, a sulfide solid electrolyte having high ionic conductivity and robustness may be prepared.

The sulfide solid electrolyte particles according to some example embodiments, e.g., may be prepared through a first heat treatment of mixing sulfur-containing raw materials and firing at about 120° C. to about 350° C. and a second heat treatment of mixing the resultant of the first heat treatment and firing the same at about 350° C. to about 800° C. The first heat treatment and the second heat treatment may be performed in an inert gas or nitrogen atmosphere, respectively. The first heat treatment may be performed for about 1 hour to about 10 hours, and the second heat treatment may be performed for about 5 hours to about 20 hours. Small raw materials may be milled through the first heat treatment, and a final solid electrolyte can be synthesized through the second heat treatment. Through such two or more heat treatments, a sulfide solid electrolyte having high ionic conductivity and high performance can be obtained, and such a solid electrolyte may be suitable for mass production. For example, the temperature of the first heat treatment may be about 150° C. to about 330° C. (e.g., about 200° C. to about 300° C.), and the temperature of the second heat treatment may be about 380° C. to about 700° C. (e.g., about 400° C. to about 600° C.).

For example, the sulfide solid electrolyte particles may include argyrodite-type sulfide. The sulfide solid electrolyte particles may have high ionic conductivity close to the range of about 10⁻⁴ to about 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state battery including the same may have improved battery performance such as rate capability, coulombic efficiency, and cycle-life characteristics.

For example, the argyrodite-type sulfide solid electrolyte may include the compound represented by Chemical Formula 10.

(LiₐM¹¹_{b}M¹²_{c})(P_{d}M¹³ₑ)(S_{f}M¹⁴_{g})Xₕ [Chemical Formula 10]

In Chemical Formula 10, 4≤a≤8, M¹¹ may be Mg, Cu, Ag, or a combination thereof, 0≤b<0.5, M¹² may be Na, K, or a combination thereof, 0≤c<0.5, M¹³ may be Sn, Zn, Si, Sb, Ge, or a combination thereof, 0<d<4, 0≤e<1. M¹⁴ may be O, SOₙ, or a combination thereof, 1.5≤n≤5, 3≤f≤12, 0≤g<2, X may be F, Cl, Br, I, or a combination thereof, and 0≤h≤2.

For example, in Chemical Formula 10, a halide element (X) may be necessarily included, and in this case, it may be expressed as 0<h≤2. For example, the M¹¹ element may be necessarily included in Chemical Formula 10, and in this case, it may be expressed as 0<b<0.5. In Chemical Formula 10, M¹³ may be understood as an element substituted for P and may be 0<e<1. In Chemical Formula 10, M¹⁴ may be substituted for S, e.g., 0<g<2 and 3≤f≤7. If M¹⁴ is SOₙ, SOₙ may be, e.g., S₄O₆, S₃O₆, S₂O₃, S₂O₄, S₂O₅, S₂P₆, S₂O₇, S₂O₈, SO₄, SO₅, or SO₄.

For example, in Chemical Formula 10, a+b+c+h=7, d+e=1, and f+g+h=6. As a specific example, the argyrodite-type sulfide solid electrolyte may include Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

The argyrodite-type sulfide solid electrolyte may be produced, e.g., by mixing raw materials such as lithium sulfide, phosphorus sulfide, and optionally lithium halide. After mixing them, heat treatment may be performed. The heat treatment may be performed at a temperature range of about 400° C. to about 600° C. (e.g., about 450° C. to about 500° C. or about 460° C. to about 490° C.) for about 5 hours to about 30 hours (e.g., about 10 hours to about 24 hours or about 15 hours to about 20 hours). If heat treated under the above conditions, ionic conductivity may be maximized. The heat treatment may include, e.g., two or more heat treatment steps. The method of preparing the argyrodite-type sulfide solid electrolyte may include, e.g., a first heat treatment in which raw materials are mixed and fired at about 120° C. to about 350° C., and a second heat treatment in which the resultant of the first heat treatment is mixed again and fired at about 350° C. to about 800° C.

The sulfide solid electrolyte particle may be a mixture of elementary particles having an average particle diameter of about 0.1 μm to about 1.9 μm and large particles having an average particle diameter of about 2.0 μm to about 5.0 μm.

The average particle diameter of the sulfide solid electrolyte particles may be measured using an electron microscope image, e.g., a particle size distribution may be obtained by measuring the size (diameter or length of the major axis) of about 20 particles in a scanning electron microscope image, and D₅₀ may be calculated therefrom.

The sulfide solid electrolyte may be included in an amount of about 90 wt % to about 99 wt % (e.g., about 95 wt % to about 99 wt %) based on 100 wt % of the solid electrolyte layer.

The solid electrolyte layer may further include an oxide solid electrolyte, a halide solid electrolyte, or a combination thereof.

The oxide solid electrolyte may include, e.g., Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂ ceramics, Garnet ceramics Li₃₊ₓLa₃M₂O₁₂ (wherein M=Te, Nb, or Zr; x is an integer of 1 to 10), or a mixture thereof.

For example, the solid electrolyte layer may further include the halide solid electrolyte. The halide solid electrolyte contains a halogen element as a main component, meaning that the ratio of the halide element is greater than or equal to about 50 mol %, greater than or equal to about 70 mol %, greater than or equal to about 90 mol %, or 100 mol % based on all elements constituting the solid electrolyte. For example, the halide solid electrolyte may not contain sulfur element.

The halide solid electrolyte may contain lithium element, metal element other than lithium, and halogen element. The metal element excluding the lithium may include Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof. The halogen element may be F, Cl, Br, I, or a combination thereof, e.g., Cl, Br, or a combination thereof. The halide solid electrolyte may be, e.g., LiₐM₁X₆ (M is Al, As, B, Bi, Ca, Cd, Co, Cr, Fe, Ga, Hf, In, Mg, Mn, Ni, Sb, Sc, Sn, Ta, Ti, Y, Zn, Zr, or a combination thereof, X may be F, Cl, Br, I, or a combination thereof, and 2≤a≤3). The halide solid electrolyte may include, e.g., Li₂ZrCl₆, Li_{2.7}Y_{0.7}Zr_{0.3}Cl₆, Li_{2.5}Y_{0.5}Zr_{0.5}Cl₆, Li_{2.5}In_{0.5}Zr_{0.5}Cl₆, Li₂In_{0.5}Zr_{0.5}Cl₆, Li₃YBr₆, Li₃YCl₆, Li₃YBr₂Cl₄, Li₃YbCl₆, Li_{0.6}Hf_{0.4}Yb_{0.6},Cl₆, or a combination thereof.

The solid electrolyte layer may further include the binder. The binder may include, e.g., a nitrile-butadiene rubber, a hydrogenated nitrile-butadiene rubber, a styrene-butadiene rubber, an acrylated styrene-butadiene rubber, an acrylonitrile-butadiene rubber, an acrylic rubber, butyl rubber, a fluorine rubber, a natural rubber, polydimethylsiloxane, polyethyleneoxide, polyvinylpyrrolidone, polyvinylpyridine, chlorosulfonatedpolyethylene, polyvinyl alcohol, polytetrafluoroethylene, polyvinylidene fluoride, a polyvinylidene fluoride-hexafluoropropylene copolymer, polyvinylchloride, carboxylated polyvinylchloride, polyvinylfluoride, polyethylene, polypropylene, an ethylene-propylene copolymer, an ethylene-propylene-diene copolymer, polyamideimide, polyimide, poly(meth)acrylate, polyacrylonitrile, polystyrene, polyurethane, a copolymer thereof, or a combination thereof.

The binder may be included in an amount of about 0.1 wt % to about 3 wt % (e.g., about 0.5 wt % to about 2 wt % or about 0.5 wt % to about 1.5 wt %), based on 100 wt % of the solid electrolyte layer. If the binder is included in the above range, the components in the solid electrolyte layer can be well combined without reducing the ionic conductivity of the solid electrolyte, thereby improving the durability and reliability of the battery.

The solid electrolyte layer may optionally further include an alkali metal salt, and/or an ionic liquid, and/or a conductive polymer.

For example, the alkali metal salt may be a lithium salt. The amount of the lithium salt in the solid electrolyte layer may be greater than or equal to about 1 M, e.g., about 1 M to about 4 M. In this case, the lithium salt can improve ionic conductivity by improving lithium ion mobility in the solid electrolyte layer.

The lithium salt may be implemented, and may include, e.g., LiPF₆, LiBF₄, LiSbF₆, LiAsF₆, LiClO₄, LiAlO₂, LiAlCl₄, LiPO₂F₂, LiCl, LiI, LiSCN, LiN(CN)₂, lithium bis(oxalato)borate (LiBOB), lithium difluoro (oxalato)borate (LiDFOB), lithium difluorobis(oxalato)phosphate (LiDFBP), lithium bis(trifluoromethane sulfonyl)imide (LiTFSI), lithium bis(fluoro)sulfonyl)imide (LiFSI), lithium bis(pentafluoroethanesulfonyl)imide (LiBETI), lithium trifluoromethane sulfonate, lithium tetrafluoroethane sulfonate, or a combination thereof.

For example, the lithium salt may be an imide lithium salt such as LiTFSI, LiFSI, LiBETI, or a combination thereof. The imide lithium salt can maintain or improve ionic conductivity by maintaining appropriate chemical reactivity with ionic liquids.

The ionic liquid has a melting point below room temperature, so it is in a liquid state at room temperature and refers to a salt or room temperature molten salt composed of ions alone.

The ionic liquid may be a compound including at least one cation selected from a) ammonium, pyrrolidinium, pyridinium, pyrimidinium, imidazolium, piperidinium, pyrazolium, oxazolium, pyridazinium, phosphonium, sulfonium, or triazolium cation, and a mixture thereof, and at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, e.g., one or more selected from N-methyl-N-propylpyrrolidinium bis(trifluoromethanesulfonyl)imide N-butyl-N-methylpyrrolidium bis(3-trifluoromethylsulfonyl) imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be about 0.1:99.9 to about 90:10 (e.g., about 10:90 to about 90:10, about 20:80 to about 90:10, about 30:70 to about 90:10, about 40:60 to about 90:10, or about 50:50 to about 90:10). The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

A thickness of the solid electrolyte layer 300 may be about 5 μm to about 200 m (e.g., about 20 μm to about 150 μm or about 40 μm to about 100 m). For example, the solid electrolyte layer 300 may be thicker than the safety functional layer 205.

### Negative Electrode

The negative electrode for an all-solid-state battery may include a current collector and a negative electrode active material layer on the current collector. The negative electrode active material layer may include negative electrode active material, may further include a binder and/or a conductive material, and optionally include the solid electrolyte.

The negative electrode active material may include a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, e.g., crystalline carbon, amorphous carbon, or a combination thereof as a carbon negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metals from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

For example, the negative electrode active material may include silicon-carbon composite particles. An average particle diameter (D₅₀) of the silicon-carbon composite particles may be, e.g., about 0.5 μm to about 20 μm. The average particle diameter (D₅₀) is measured with a particle size analyzer and means a diameter of particles with a cumulative volume of 50 volume % in the particle size distribution. Silicon may be included in an amount of about 10 wt % to about 60 wt % and carbon may be included in an amount of about 40 wt % to about 90 wt %, based on 100 wt % of the silicon-carbon composite particles. For example, the silicon-carbon composite particles may include a core including silicon particles, and a carbon coating layer on the surface of the core. An average particle diameter (D₅₀) of the silicon particles may be about 10 nm to about 1 m or about 10 nm to about 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to about 100 nm.

As an example, the silicon-carbon composite particles may include a core including silicon particles and crystalline carbon, and a carbon coating layer on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be formed from coal pitch, mesophase pitch, petroleum pitch, coal oil, heavy petroleum oil, or a polymer resin (phenolic resin, furan resin, polyimide, etc.). Herein, an amount of the crystalline carbon may be about 10 wt % to about 70 wt % and an amount of the amorphous carbon may be about 20 wt % to about 40 wt %, based on 100 wt % of the silicon-carbon composite particles.

In the silicon-carbon composite particle, the core may include a void in the center. A radius of the void may be about 30 length % to about 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si negative electrode active material or Sn negative electrode active material may be used by mixing with a carbon negative electrode active material. When using a mixture of Si negative electrode active material or Sn negative electrode active material and carbon negative electrode active material, a mixing ratio thereof may be about 1:99 to about 90:10 by weight.

An amount of the negative electrode active material in the negative electrode active material layer may be about 95 wt % to about 99 wt %, based on a total weight of the negative electrode active material layer.

In some example embodiments, the negative electrode active material layer further includes the binder and optionally may further include the conductive material. An amount of the binder in the negative electrode active material layer may be about 1 wt % to about 5 wt %, based on a total weight of the negative electrode active material layer. In addition, if a conductive material is further included, the negative electrode active material layer may include about 90 wt % to about 98 wt % of the negative electrode active material, about 1 wt % to about 5 wt % of the binder, and about 1 wt % to about 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose compound capable of imparting viscosity as a type of thickener may be further included. As this cellulose compound, one or more types of carboxymethyl cellulose, hydroxypropylmethyl cellulose, methyl cellulose, or an alkali metal salt thereof may be used. The alkali metal may be Na, K, or Li. The amount of the thickener used may be about 0.1 parts by weight to about 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon material such as natural graphite, artificial graphite, carbon black, acetylene black, ketjen black, a carbon fiber, a carbon nanofiber, a carbon nanotube, and the like; a metal material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

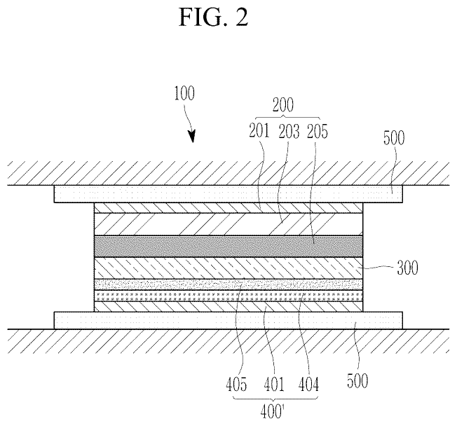

FIG. 2 is a schematic cross-sectional view of an all-solid-state rechargeable battery including a precipitation-type negative electrode.

Referring to FIG. 2, the precipitation-type negative electrode 400′ may include a current collector 401 and a negative electrode coating layer 405 on the current collector 401. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, e.g., the current collector 401, the lithium metal layer 404 on the current collector 401, and the negative electrode coating layer 405 on the metal layer 404. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

In this case, the aforementioned area or the solid electrolyte layer 300 may be referred to as a surface in contact with the negative electrode coating layer 405. The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, e.g., gold, platinum, palladium, silicon, silver, aluminum, bismuth, tin, zinc, or a combination thereof, and may be composed of one of these or various types of alloys. If the metal is present in particle form, an average particle diameter (D₅₀) thereof may be less than or equal to about 4 μm, e.g., about 10 nm to about 4 μm.

The carbon material may be, e.g., crystalline carbon, amorphous carbon, or a combination thereof. The crystalline carbon may be, e.g., natural graphite, artificial graphite, mesophase carbon microbeads, or a combination thereof. The amorphous carbon may be, e.g., carbon black, activated carbon, acetylene black, denka black, ketjen black, or a combination thereof.

If the negative electrode coating layer 405 includes the metal and the carbon material, the metal and the carbon material may be, e.g., mixed in a weight ratio of about 1:10 to about 2:1. Herein, the precipitation of the lithium metal may be effectively promoted and improve characteristics of the all-solid-state battery. The negative electrode coating layer 405 may include, e.g., a carbon material on which a catalyst metal is supported or a mixture of metal particles and carbon material particles.

The negative electrode coating layer 405 may include, e.g., the lithiophilic metal and amorphous carbon, and in this case, the deposition of lithium metal may be effectively promoted. For example, the negative electrode coating layer 405 may include a composite in which a lithiophilic metal is supported on amorphous carbon.

The negative electrode coating layer 405 may further include a binder, e.g., a conductive binder. Additionally, the negative electrode coating layer 405 may further include general additives, e.g., a filler, a dispersant, an ion conductive agent, and the like.

For example, a thickness of the negative electrode coating layer 405 may be about 100 nm to about 20 μm (e.g., about 500 nm to about 10 μm or about 1 μm to about 5 μm).

The precipitation-type negative electrode 400′ may further include a thin film, e.g., on the surface of the current collector (i.e., between the current collector and the negative electrode catalyst layer). The thin film may include an element capable of forming an alloy with lithium. The element capable of forming an alloy with lithium may be, e.g., gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, e.g., in a vacuum deposition method, a sputtering method, a plating method, and the like. The thin film may have, e.g., a thickness of about 1 nm to about 500 nm.

The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be about 1 μm to about 500 m (e.g., about 1 μm to about 200 μm, about 1 μm to about 100 μm, or about 1 μm to about 50 μm). If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

An all-solid-state rechargeable battery may be a unit cell with a structure of positive electrode/solid electrolyte layer/negative electrode, a bicell with a structure of negative electrode/solid electrolyte layer/positive electrode/solid electrolyte layer/negative electrode, or a stacked battery in which the structure of the unit cell is repeated.

For example, the shape of the all-solid-state rechargeable battery may be coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, e.g., in an electric bicycle or a power tool. In addition, the all-solid-state rechargeable battery may be used in various fields such as portable electronic devices.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

### Example 1-1

### 1. Manufacturing of Positive Electrode

84.9 wt % of a LiNi_{0.945}Co_{0.04}Al_{0.015}O₂ positive electrode active material, 13.61 wt % of Li₆PS₅Cl of an argyrodite-type solid electrolyte (D₅₀=1 μm), 1 wt % of a PVdF binder, 0.35 wt % of a carbon nanotube (CNT) conductive material, and 0.14 wt % of a hydrogenated nitrile butadiene rubber (HNBR) as a dispersant were mixed in an isobutyl isobutyrate (IBIB) solvent to prepare a positive electrode composition. This positive electrode composition was coated on a positive electrode current collector, followed by drying to form a positive electrode active material layer.

On the positive electrode active material layer, about 1 m-thick of a safety functional layer was formed by coating and drying a safety functional layer composition, which was prepared by mixing 1 part by weight of a PVdF binder based on 100 parts by weight of LiFePO₄. Subsequently, a warm isostatic press (WIP; 500 Mpa, 85° C., 30 min) was applied thereto to prepare a positive electrode.

2. Manufacturing of All-solid-state Rechargeable Battery Cell

Carbon black with a primary particle diameter of about 30 nm and silver (Ag) with an average particle diameter (D₅₀) of about 60 nm were mixed in a weight ratio of 3:1 to prepare an Ag/C composite, and 0.25 g of the composite was added to 2 g of an NMP solution including 7 wt % of a polyvinylidene fluoride binder, followed by mixing to prepare a negative electrode coating layer composition. This negative electrode coating layer composition was coated on a negative electrode current collector, followed by drying to form a negative electrode coating layer on the current collector, thereby manufacturing a precipitation-type negative electrode.

A composition for a solid electrolyte layer was prepared by mixing Li₆PS₅Cl (D₅₀=3 μm) of an argyrodite-type solid electrolyte with an IBIB solvent including an acryl binder. The composition included 98.5 wt % of the solid electrolyte and 1.5 wt % of the binder. The composition was cast on a releasing film, followed by drying at room temperature to form a solid electrolyte layer.

The manufactured positive electrode, negative electrode, and solid electrolyte layer were cut to stack the solid electrolyte layer on the negative electrode and, subsequently, the positive electrode thereon. The obtained stack was sealed into a pouch shape and treated with a warm isostatic press at 500 MPa at a high temperature of 80° C. for 30 minutes to manufacture an all-solid-state rechargeable battery cell.

### Example 1-2

A positive electrode and an all-solid-state rechargeable battery cell were manufactured substantially in the same manner as in Example 1-1, except that the thickness of the safety functional layer was changed to 5 μm in the manufacturing of the positive electrode.

### Example 1-3

A positive electrode and an all-solid-state rechargeable battery cell were manufactured substantially in the same manner as in Example 1-1, except that the thickness of the safety functional layer was changed to 8 μm in the manufacturing of the positive electrode.

### Comparative Example 1-1

A positive electrode and an all-solid-state rechargeable battery cell were manufactured substantially in the same manner as in Example 1-1, except that the thickness of the safety functional layer was changed to 10 μm in the manufacturing of the positive electrode.

### Comparative Example 1-2

A positive electrode and an all-solid-state rechargeable battery cell were manufactured substantially in the same manner as in Example 1-1, except that the positive electrode active material layer alone was formed on the current collector without introducing the safety functional layer in the manufacturing of the positive electrode.

### Example 2-1

### 1. Manufacturing of Positive Electrode

84.9 wt % of a LiNi_{0.945}Co_{0.04}Al_{0.015}O₂ positive electrode active material, 13.61 wt % of Li₆PS₅Cl of an argyrodite-type solid electrolyte (D₅₀=1 μm), 1 wt % of a PVdF binder, 0.35 wt % of a carbon nanotube conductive material, and 0.14 wt % of a hydrogenated nitrile butadiene rubber (HNBR) as a dispersant were mixed in an isobutyl isobutyrate (IBIB) solvent to prepare a positive electrode composition. This positive electrode composition was coated on a positive electrode current collector and dried to form a positive electrode active material layer.

On the positive electrode active material layer, a safety functional layer composition was prepared by mixing LiFePO₄ with Li₆PS₅Cl of an argyrodite-type solid electrolyte at a weight ratio of 95:5. Subsequently, a warm isostatic press (WIP; 500 Mpa, 85° C., 30 min) was applied thereto to prepare a positive electrode.

Otherwise, a positive electrode and an all-solid-state rechargeable battery cell were manufactured in substantially the same manner as Example 1-1.

### Example 2-2

A positive electrode and an all-solid-state rechargeable battery cell were manufactured substantially in the same manner as in Example 2-1, except that the weight ratio of LiFePO₄ and Li₆PS₅Cl in the safety functional layer of the positive electrode was changed to 90:10.

### Example 2-3

A positive electrode and an all-solid-state rechargeable battery cell were manufactured substantially in the same manner as in Example 2-1, except that the weight ratio of LiFePO₄ and Li₆PS₅Cl in the safety functional layer of the positive electrode was changed to 85:15.

### Example 2-4

A positive electrode and an all-solid-state rechargeable battery cell were manufactured substantially in the same manner as in Example 2-1, except that the weight ratio of LiFePO₄ and Li₆PS₅Cl in the safety functional layer of the positive electrode was changed to 80:20.

### Example 2-5

A positive electrode and an all-solid-state rechargeable battery cell were manufactured substantially in the same manner as in Example 2-1, except that the weight ratio of LiFePO₄ and Li₆PS₅Cl in the safety functional layer of the positive electrode was changed to 75:25.

### Comparative Example 2-1

A positive electrode and an all-solid-state rechargeable battery cell were manufactured substantially in the same manner as in Example 2-1, except that the positive electrode active material layer alone was formed on the current collector without introducing the safety functional layer in the manufacturing of the positive electrode.

### Example 3-1

### 1. Manufacturing of Positive Electrode

84.9 wt % of a LiNi_{0.945}Co_{0.04}Al_{0.015}O₂ positive electrode active material, 13.61 wt % of Li₆PS₅Cl of an argyrodite-type solid electrolyte (D₅₀=1 μm), 1 wt % of a PVdF binder, 0.35 wt % of a carbon nanotube conductive material, and 0.14 wt % of a hydrogenated nitrile butadiene rubber (HNBR) as a dispersant were mixed in an isobutyl isobutyrate (IBIB) solvent to prepare a positive electrode composition. This positive electrode composition was coated on a positive electrode current collector and dried to form a positive electrode active material layer.

On the positive electrode active material layer, a safety functional layer composition was prepared by mixing LiFePO₄ with Li₆PS₅Cl of an argyrodite-type solid electrolyte at a weight ratio of 85:15, with an additional CNT in an amount of 0.5 parts by weight, based on 100 parts by weight of the mixture (i.e., the LiFePO₄ with Li₆PS₅Cl mixture). Subsequently, a warm isostatic press (WIP; 500 Mpa, 85° C., 30 min) was applied thereto to prepare a positive electrode.

Otherwise, a positive electrode and an all-solid-state rechargeable battery cell were manufactured in substantially the same manner as Example 1-1.

### Examples 3-2 to 3-5

Positive electrode and all-solid-state rechargeable battery cells were manufactured substantially in the same manner as in Example 3-1, except that the amounts of the CNT conductive material in the safety functional layer of the positive electrode were changed as shown in Table 3.

### Comparative Example 3-1

A positive electrode and an all-solid-state rechargeable battery cell were manufactured in substantially the same manner as Example 3-1, except that the amount of the CNT conductive material in the safety functional layer of the positive electrode was changed to 10 parts by weight.

### Comparative Example 3-2

A positive electrode and an all-solid-state rechargeable battery cell were manufactured substantially in the same manner as in Example 3-1, except that the positive electrode active material layer alone was formed on the current collector without introducing the safety functional layer in the manufacturing of the positive electrode.

### EVALUATION EXAMPLES

### Evaluation Example 1-1: Evaluation of High Rate Capability

The all-solid-state rechargeable battery cells of Examples 1-1 to 1-3 and Comparative Examples 1-1 to 1-2 were charged to 4.25 V at a constant current of 0.1 C and charged to 0.05 C at a constant voltage to measure charge capacity and then, discharged to 2.5 V at a constant current of 0.1 C to measure discharge capacity at 45° C. Subsequently, the all-solid-state rechargeable battery cells were charged to 4.25 V at a constant current of 0.1 C and to 0.05 C at a constant voltage to measure charge capacity and then discharged to 2.5 V at a constant current of 1.0 C at 45° C. to measure discharge capacity. A ratio of the discharge capacity at 1.0 C to the discharge capacity at 0.1 C was calculated and then, shown as rate capability (%) in Table 1.

### Evaluation Example 1-2: Evaluation of Cycle-life Characteristics

Subsequently to Evaluation Example 1-1, the all-solid-state rechargeable battery cells were 300 cycles repeatedly charged and discharged at 0.33 C within a voltage range of 2.5 V to 4.25 V at 45° C. to evaluate cycle-life characteristics.

A ratio of the discharge capacity after 300 cycles to the initial discharge capacity was calculated and then shown as capacity retention rate (%) in Table 1. A case of maintaining 80% or more of the capacity retention rate (%) was determined to be satisfactory.

### Evaluation Example 1-3: Evaluation of Penetration Safety

The all-solid-state rechargeable battery cells of Examples 1-1 to 1-3 and Comparative Examples 1-1 to 1-2 were charged at a constant current of 0.1 C to 4.25 V and at a constant voltage to 0.05 C at 45° C. The charged all-solid-state rechargeable battery cells were allowed to stand for 1 hour at room temperature to evaluate penetration safety. The penetration safety evaluation was performed by using the center of each of the all-solid-state rechargeable battery cells with a stainless steel nail with a diameter of 3 mm at 50 mm/s. Herein, ‘OK’ was given to no ignition, but ‘NG’ was given to ignition, and the results are shown in Table 1.

TABLE 1

| | | | | Capacity | |
|---|---|---|---|---|---|
| | | | | retention | |
| | Safety | | Rate | rate | Evaluation |
| | functional | Thick- | capability | (%, @ | of |
| | layer | ness | (1 C/0.1 | 300 cyc, | penetration |
| | composition | (μm) | C, %) | 45 ° C.) | safety |
| Example | LiFePO₄ | 1 | 84.2 | 83.3 | OK |
| 1-1 | | | | | |
| Example | LiFePO₄ | 5 | 83.9 | 83.1 | OK |
| 1-2 | | | | | |
| Example | LiFePO₄ | 8 | 82.1 | 81.4 | OK |
| 1-3 | | | | | |
| Compar- | LiFePO₄ | 10 | 71.8 | 75.1 | OK |
| ative | | | | | |
| Example | | | | | |
| 1-1 | | | | | |
| Compar- | — | 0 | 87.3 | 85.2 | NG |
| ative | | | | | |
| Example | | | | | |
| 1-2 | | | | | |

Referring to Table 1, the all-solid-state rechargeable battery cells of Examples 1-1 to 1-3 exhibited excellent penetration safety, compared to the cell of Comparative Example 1-2, as well as equivalent rate capability and capacity retention rate to the battery cell of Comparative Example 1-2. In addition, Comparative Example 1-1, of which the safety functional layer was too thick, exhibited deteriorated rate capability and capacity retention rate, compared to the cells of Examples 1-1 to 1-3.

### Evaluation Example 2-1: Evaluation of High Rate Capability

The all-solid-state rechargeable battery cells of Examples 2-1 to 2-5 and Comparative Example 2-1 were charged to 4.25 V at a constant current of 0.1 C and charged to 0.05 C at a constant voltage to measure charge capacity, followed by discharging to 2.5 V at a constant current of 0.1 C to measure discharge capacity at 45° C. Subsequently, the all-solid-state rechargeable battery cells were charged to 4.25 V at a constant current of 0.1 C and to 0.05 C at a constant voltage to measure charge capacity and then discharged to 2.5 V at a constant current of 1.0 C at 45° C. to measure discharge capacity. A ratio of the discharge capacity at 1.0 C to the discharge capacity at 0.1 C was calculated and then shown as rate capability (%) in Table 2.

### Evaluation Example 2-2: Evaluation of Cycle-life Characteristics

Subsequently to Evaluation Example 2-1, the all-solid-state rechargeable battery cells according to Examples 2-1 to 2-5 and Comparative Example 2-1 were 300 cycles repeatedly charged and discharged at 0.33 C within a voltage range of 2.5 V to 4.25 V at 45° C. to evaluate cycle-life characteristics. A ratio of the discharge capacity after 300 cycles to the initial discharge capacity was calculated and then shown as capacity retention rate (%) in Table 2. A case of maintaining 80% or more of the capacity retention rate (%) was determined to be satisfactory.

### Evaluation Example 2-3: Evaluation of Penetration Safety

The all-solid-state rechargeable battery cells of Examples 2-1 to 2-5 and Comparative Example 2-1 were charged at a constant current of 0.1 C to 4.25 V and at a constant voltage to 0.05 C at 45° C. The charged all-solid-state rechargeable battery cells were allowed to stand for 1 hour at room temperature to evaluate penetration safety.

The penetration safety evaluation was performed by using the center of each of the all-solid-state rechargeable battery cells with a stainless steel nail with a diameter of 3 mm at 50 mm/s. Herein, ‘OK’ was given to no ignition, but ‘NG’ was given to ignition, and the results are shown in Table 2.

TABLE 2

| | Safety | | | |
|---|---|---|---|---|
| | functional | | Capacity | Evaluation |
| | layer | | retention rate | of |
| | LiFePO₄: | Rate capability | (%, @ 300 | penetration |
| | Li₆PS₅Cl | (1 C/0.1 C, %) | cyc, 45° C.) | safety |
| Example 2-1 | 95:5 | 85.8 | 84.1 | OK |
| Example 2-2 | 90:10 | 86.1 | 84.4 | OK |
| Example 2-3 | 85:15 | 86.9 | 84.9 | OK |
| Example 2-4 | 80:20 | 87.3 | 85.2 | OK |
| Example 2-5 | 75:25 | 87.2 | 85.1 | OK |
| Comparative | — | 87.3 | 85.2 | NG |
| Example 2-1 | | | | |

Referring to Table 2, in the case of the all-solid-state rechargeable battery cells of Examples 2-1 to 2-5, penetration safety was superior to that of Comparative Example 2-1, and also, equivalent rate capability and capacity retention rate to the battery cell of Comparative Example 2-1.

### Evaluation Example 3-1: Evaluation of High Rate Capability

The all-solid-state rechargeable battery cells of Examples 3-1 to 3-5 and Comparative Examples 3-1 to 3-2 were charged to 4.25 V at a constant current of 0.1 C and charged to 0.05 C at a constant voltage to measure charge capacity and then, discharged to 2.5 V at a constant current of 0.1 C to measure discharge capacity at 45° C. Subsequently, the all-solid-state rechargeable battery cells were charged to 4.25 V at a constant current of 0.1 C and to 0.05 C at a constant voltage to measure charge capacity and then, discharged to 2.5 V at a constant current of 1.0 C at 45° C. to measure discharge capacity. A ratio of the discharge capacity at 1.0 C to the discharge capacity at 0.1 C was calculated and then, shown as rate capability (%) in Table 3.

### Evaluation Example 3-2: Evaluation of Cycle-life Characteristics

Subsequently to Evaluation Example 3-1, the all-solid-state rechargeable battery cells according to Examples 3-1 to 3-5 and Comparative Examples 3-1 to 3-2 were 300 cycles repeatedly charged and discharged at 0.33 C within a voltage range of 2.5 V to 4.25 V at 45° C. to evaluate cycle-life characteristics. A ratio of the discharge capacity after 300 cycles to the initial discharge capacity was calculated and then, shown as capacity retention rate (%) in Table 3. A case of maintaining 80% or more of the capacity retention rate (%) was determined to be satisfactory.

### Evaluation Example 3-3: Evaluation of Penetration Safety

The all-solid-state rechargeable battery cells of Examples 3-1 to 3-5 and Comparative Examples 3-1 to 3-2 were charged at a constant current of 0.1 C to 4.25 V and at a constant voltage to 0.05 C at 45° C. The charged all-solid-state rechargeable battery cells were allowed to stand for 1 hour at room temperature to evaluate penetration safety. The penetration safety evaluation was performed by using the center of each of the all-solid-state rechargeable battery cells with a stainless steel nail with a diameter of 3 mm at 50 mm/s. Herein, ‘OK’ was given to no ignition, but ‘NG’ was given to ignition, and the results are shown in Table 3.

TABLE 3

| | Safety functional layer | | | | |
|---|---|---|---|---|---|
| | composition | | | | |
| | | Amount of | | Capacity | |
| | | conductive | Rate | retention | Evaluation |
| | | material | capability | rate (%, | of |
| | LiFePO₄: | (parts by | (1 C/ | @300 cyc, | penetration |
| | Li₆PS₅Cl | weight) | 0.1 C, %) | 45° C.) | safety |
| Example 3-1 | 85:15 | 0.5 | 85.3 | 83.9 | OK |
| Example 3-2 | 85:15 | 1.0 | 85.8 | 84.2 | OK |
| Example 3-3 | 85:15 | 1.5 | 86.2 | 84.6 | OK |
| Example 3-4 | 85:15 | 2.0 | 86.5 | 84.5 | OK |
| Example 3-5 | 85:15 | 5.0 | 86.9 | 84.9 | OK |
| Comparative | 85:15 | 10 | 87.1 | 85.1 | NG |
| Example 3-1 | | | | | |
| Comparative | — | — | 87.3 | 85.2 | NG |
| Example 3-2 | | | | | |

Referring to Table 3, in the case of the all-solid-state rechargeable battery cells of Examples 3-1 to 3-5, penetration safety was superior to those of Comparative Examples 3-1 to 3-2, and also, equivalent rate capability and capacity retention rate to the battery cells of Comparative Examples 3-1 to 3-2. In the case of Comparative Example 3-1, the amount of the conductive material included in the safety functional layer is excessive, and thus the penetration safety is lower than those of Examples.

By way of summation and review, an all-solid-state rechargeable battery is provided that can effectively improve the safety of the battery by reducing the heat generation amount of the battery and preventing thermal runaway.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An all-solid-state rechargeable battery, comprising
a positive electrode including:
a positive electrode current collector,
a positive electrode active material layer on the positive electrode current collector, the positive electrode active material layer including a positive electrode active material and a sulfide solid electrolyte, and
a safety functional layer on the positive electrode active material layer, the safety functional layer including an olivine positive electrode active material;
a negative electrode; and
a solid electrolyte layer between the positive electrode and the negative electrode, the solid electrolyte layer including the sulfide solid electrolyte.

2. The all-solid-state rechargeable battery as claimed in claim 1, wherein the olivine positive electrode active material includes lithium iron phosphate, lithium manganese iron phosphate, lithium manganese phosphate, lithium titanium phosphate, or a combination thereof.

3. The all-solid-state rechargeable battery as claimed in claim 1, wherein the olivine positive electrode active material is represented by Chemical Formula 1, Chemical Formula 2, Chemical Formula 3, Chemical Formula 4, or Chemical Formula 5:
Liₐ₁Fe₍₁₋ₓ₁₎M¹ₓ₁PO₄ [Chemical Formula 1]
wherein, in Chemical Formula 1, 0.90≤a1≤1.5, 0≤x1≤0.4, and M¹ is Al, Ca, Ce, Cr, Cu, Co, La, Mg, Mo, Nb, Ni, Sn, Sr, V, W, Y, Zn, Zr, or a combination thereof,
Liₐ₂Mnₓ₂Fe_{(1-x2-y2)}M²_{y2}PO₄ [Chemical Formula 2]
wherein, in Chemical Formula 2, 0.90≤a2≤1.5, 0.1≤x2≤0.9, and M² is Al, Ca, Ce, Cr, Cu, Co, La, Mg, Mo, Nb, Ni, Sn, Sr, V, W, Y, Zn, Zr, or a combination thereof,
Liₐ₃Mn₍₁₋ₓ₃₎M³ₓ₃PO₄ [Chemical Formula 3]
wherein, in Chemical Formula 3, 0.90≤a3≤1.5, 0≤x3≤0.4, and M³ is Al, Ca, Ce, Cr, Cu, Co, La, Mg, Mo, Nb, Ni, Sn, Sr, V, W, Y, Zn, Zr, or a combination thereof,
Liₐ₄Ti₍₂₋ₓ₄₎M⁴ₓ₄(PO₄)₃ [Chemical Formula 4]
wherein, in Chemical Formula 4, 0.90≤a4≤1.5, 0≤x4≤0.4, and M⁴ is Al, Ca, Ce, Cr, Cu, Co, La, Mg, Mo, Nb, Ni, Sn, Sr, V, W, Y, Zn, Zr, or a combination thereof, and
Liₐ₅Ti₍₁₋ₓ₅₎M⁵ₓ₅PO₅ [Chemical Formula 5]
wherein, in Chemical Formula 5, 0.90≤a5≤1.5, 0≤x5≤0.4, and M⁵ is Al, Ca, Ce, Cr, Cu, Co, La, Mg, Mo, Nb, Ni, Sn, Sr, V, W, Y, Zn, Zr, or a combination thereof.

4. The all-solid-state rechargeable battery as claimed in claim 1, wherein the olivine positive electrode active material includes LiFePO₄, LiMn_{0.7}Fe_{0.3}PO₄, LiMn_{0.6}Fe_{0.4}PO₄, LiMn_{0.5}Fe_{0.5}PO₄, LiMn_{0.4}Fe_{0.6}PO₄, LiMn_{0.3}Fe_{0.7}PO₄, LiMnPO₄, LiTiPO₅, LiTi₂(PO₄)₃, or a combination thereof.

5. The all-solid-state rechargeable battery as claimed in claim 1, wherein an average particle diameter (D₅₀) of the olivine positive electrode active material is about 10 nm to about 2 μm.

6. The all-solid-state rechargeable battery as claimed in claim 1, wherein the olivine positive electrode active material is included in an amount of about 70 wt % to about 99 wt %, based on 100 wt % of the safety functional layer.

7. The all-solid-state rechargeable battery as claimed in claim 1, wherein the safety functional layer further includes a sulfide solid electrolyte.

8. The all-solid-state rechargeable battery as claimed in claim 7, wherein the sulfide solid electrolyte is included in the safety functional layer in an amount of about 1 wt % to about 30 wt %, based on 100 wt % of the safety functional layer.

9. The all-solid-state rechargeable battery as claimed in claim 7, wherein a weight ratio of the olivine positive electrode active material and the sulfide solid electrolyte included in the safety functional layer is about 70:30 to about 97:3.

10. The all-solid-state rechargeable battery as claimed in claim 7, wherein an average particle diameter (D₅₀) of the sulfide solid electrolyte included in the safety functional layer is about 0.1 μm to about 1.9 μm.

11. The all-solid-state rechargeable battery as claimed in claim 7, wherein the sulfide solid electrolyte of the positive electrode active material layer, the sulfide solid electrolyte of the safety functional layer, and the sulfide solid electrolyte of the solid electrolyte layer are the same or different from each other, and each includes argyrodite-type sulfide.

12. The all-solid-state rechargeable battery as claimed in claim 11, wherein the argyrodite-type sulfide includes a compound represented by Chemical Formula 10:
(LiₐM¹¹_{b}M¹²_{c})(P_{d}M¹³ₑ)(S_{f}M¹⁴_{g})Xₕ [Chemical Formula 10]
wherein, in Chemical Formula 10, 4≤a≤8, M¹¹ is Mg, Cu, Ag, or a combination thereof, 0≤b<0.5, M¹² is Na, K, or a combination thereof, 0≤c<0.5, M¹³ is Sn, Zn, Si, Sb, Ge, or a combination thereof, 0<d<4, 0≤e<1, M¹⁴ is O, SOₙ, or a combination thereof, 1.5≤n≤5, 3≤f≤12, 0≤g<2, X is F, Cl, Br, I, or a combination thereof, and 0≤h≤2.

13. The all-solid-state rechargeable battery as claimed in claim 11, wherein the argyrodite-type sulfide includes Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, Li_{5.75}PS_{4.75}Cl_{1.25}, (Li_{5.69}Cu_{0.06})PS_{4.75}Cl_{1.25}, (Li_{5.72}Cu_{0.03})PS_{4.75}Cl_{1.25}, (Li_{5.69}Cu_{0.06})P(S_{4.70}(SO₄)_{0.05})Cl_{1.25}, (Li_{5.69}Cu_{0.06})P(S_{4.60}(SO₄)_{0.15})Cl_{1.25}, (Li_{5.72}Cu_{0.03})P(S_{4.725}(SO₄)_{0.025})Cl_{1.25}, (Li_{5.72}Na_{0.03})P(S_{4.725}(SO₄)_{0.025})Cl_{1.25}, Li_{5.75}P(S_{4.725}(SO₄)_{0.025})Cl_{1.25}, or a combination thereof.

14. The all-solid-state rechargeable battery as claimed in claim 1, wherein the safety functional layer further includes a conductive material.

15. The all-solid-state rechargeable battery as claimed in claim 14, wherein the conductive material includes a carbon material, a metal material, a conductive polymer, or a mixture thereof.

16. The all-solid-state rechargeable battery as claimed in claim 14, wherein the conductive material is a carbon nanotube, a carbon nanofiber, or a combination thereof.

17. The all-solid-state rechargeable battery as claimed in claim 14, wherein the conductive material is included in an amount of about 0.5 wt % to about 15 wt %, based on 100 wt % of the safety functional layer.

18. The all-solid-state rechargeable battery as claimed in claim 1, wherein the safety functional layer further includes a binder, the binder including polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, or a combination thereof.

19. The all-solid-state rechargeable battery as claimed in claim 18, wherein the binder is included in an amount of about 0.1 wt % to about 25 wt %, based on 100 wt % of the safety functional layer.

20. The all-solid-state rechargeable battery as claimed in claim 1, wherein the positive electrode active material included in the positive electrode active material layer includes a lithium nickel oxide represented by Chemical Formula 6 or lithium cobalt oxide represented by Chemical Formula 7:
Liₐ₆Niₓ₆M⁶_{y6}M⁷_{z6}O_{2-b6}X_{b6} [Chemical Formula 6]
wherein, in Chemical Formula 6, 0.9≤a6≤1.8, 0.3≤x6≤1, 0≤y6≤0.7, 0≤z6≤0.7, 0.9≤x6+y6+z6≤1.1, and 0≤b6≤0.1, M⁶ and M⁷ are each independently one or more elements selected from Al, B, Ba, Ca, Ce, Co, Cr, Cu, Fe, Mg, Mn, Mo, Nb, Si, Sn, Sr, Ti, V, W, and Zr, and X is one or more elements selected from F, P and S, and
Liₐ₇Coₓ₇M⁸_{y7}O_{2-b7}X_{b7} [Chemical Formula 7]
wherein, in Chemical Formula 7, 0.9≤a7≤1.8, 0.7≤x7≤1, 0≤y7≤0.3, 0.9≤x7+y7≤1.1, and 0≤b7≤0.1, M⁸ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

21. The all-solid-state rechargeable battery as claimed in claim 1, wherein an average particle diameter (D₅₀) of the positive electrode active material included in the positive electrode active material layer is about 1 μm to about 25 μm.

22. The all-solid-state rechargeable battery as claimed in claim 1, wherein:
the sulfide solid electrolyte of the positive electrode active material layer has an average particle diameter (D₅₀) of about 0.1 μm to about 1.9 μm, and
the sulfide solid electrolyte of the solid electrolyte layer has an average particle diameter (D₅₀) of about 2 μm to about 5 μm.

23. The all-solid-state rechargeable battery as claimed in claim 1, wherein the sulfide solid electrolyte is included in an amount of about 0.1 wt % to about 35 wt %, based on 100 wt % of the positive electrode active material layer.

24. The all-solid-state rechargeable battery as claimed in claim 1, wherein a thickness of the safety functional layer is about 1 μm to about 15 μm.

25. The all-solid-state rechargeable battery as claimed in claim 1, wherein a thickness of the solid electrolyte layer is about 5 μm to about 200 μm.

26. The all-solid-state rechargeable battery as claimed in claim 1, wherein the negative electrode includes a negative electrode current collector, a negative electrode coating layer on the negative electrode current collector, and a lithium metal layer between the negative electrode current collector and the negative electrode coating layer, the negative electrode coating layer including a carbon material, a lithiophilic metal, or a combination thereof.
